(19) United States
(12) Patent Application Publication
(10) Pub. No.: US 2014/0092318 A1
(43) Pub. Date: Apr. 3, 2014

(54) SLIDABLE TELEVISION TRACK

(71) Applicants: Sammy Carrillo, Commerce City, CO (US); Veronica Carrillo, Commerce City, CO (US); Melvin Stevenson, Commerce City, CO (US)

(72) Inventors: Sammy Carrillo, Commerce City, CO (US); Veronica Carrillo, Commerce City, CO (US); Melvin Stevenson, Commerce City, CO (US)

(21) Appl. No.: 13/633,525

(22) Filed: Oct. 2, 2012

(51) Int. Cl. H04N 5/64

(52) U.S. Cl. 348/843; 348/E05.128

(57) ABSTRACT

The present invention is a slidable television track that includes a pair of rails attached to a ceiling or a wall, a wheels track disposed between the pair of rails and a pair of roller wheels received by the wheels track. The slidable television track also includes an attachment stem that contains television cable and a plurality of electrical power wires that are utilized by a flat screen television and a television attachment bracket attached to a back portion of the flat screen television, the television attachment bracket secures the back portion of the flat screen television to the second end of the attachment stem.

### TECHNICAL FIELD & BACKGROUND

Currently there are limited options for a mobile support bracket for modern media such as a flat screen television. Modern flat screen televisions are either supported by a furniture stand or are directly affixed to a wall, neither of which provides any movement.

The present invention generally relates to a slidable track. More specifically, the invention is a slidable television track.

It is an object of the invention to provide a slidable television track that moves a flat screen television along a track into a desired position along the track.

It is an object of the invention to provide a slidable television track without a need to move a cable box or a plurality of surround sound cables as a flat screen television is moved.

It is an object of the invention to provide a slidable television track that better accommodates television related video games such as PLAYSTATION™ and WII™.

What is really needed is a slidable television track that moves a flat screen television along a track into a desired position along the track without a need to move a cable box or a plurality of surround sound cables as the flat screen television is moved that better accommodates television related video games such as PLAYSTATION™ and WII™.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front environmental view of a slidable television track, according to an embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

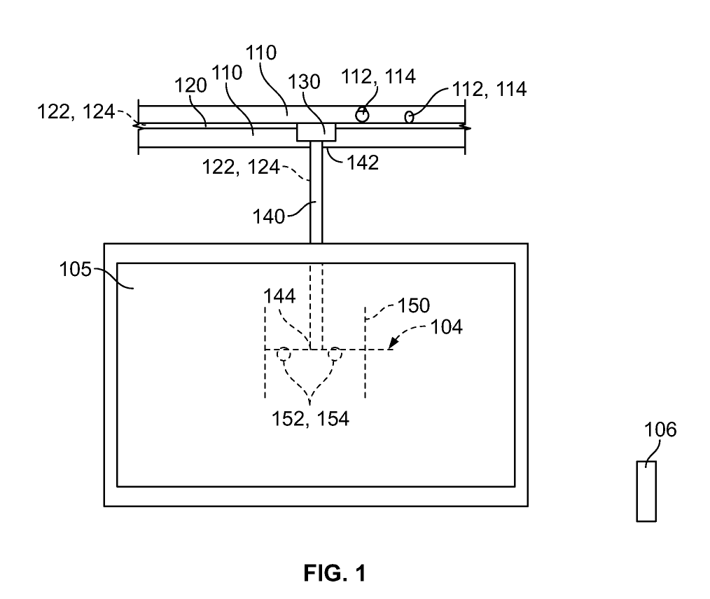

The phrase “in one embodiment” is utilized repeatedly. The phrase generally does not refer to the same embodiment, however, it may. The terms “comprising”, “having” and “including” are synonymous, unless the context dictates otherwise. FIG. 1 illustrates a front environmental view of a slidable television track 100, according to an embodiment of the present invention. The slidable television track 100 accommodates a flat screen television 105 that moves the flat screen television 105 into a desired position without a need to move a cable box or a plurality of surround sound cables (not shown) as the flat screen television 105 is moved. The flat screen television 105 can be any suitable size flat screen television that can be moved without obstruction. The slidable television track 100 also relatively better accommodates television related video games such as PLAYSTATION™ and WII™ (not shown). The flat screen television 105 can be moved along the slidable television track 100 by hand or with a remote control 106 in communication with the flat screen television 105.

The slidable television track 100 includes a pair of rails 110, a wheels track 120, a pair of roller wheels 130, an attachment stem 140 and a television attachment bracket 150. The pair of rails 110 can be attached to a ceiling or a wall with a plurality of bolts 112, a plurality of screws 114 or other suitable fasteners. FIG. 1 illustrates the slidable television track 100 attached to a ceiling. The pair of rails 110 serves as a base for the slidable television track 100. The pair of rails 110 is made of metal or any other suitable material. The wheels track 120 is disposed between the pair of rails 110. The wheels track 120 is approximately 2 inches in width but can be any suitable width. The pair of rails 110 and the wheels track 120 typically has an equal length and can be any suitable length desired by a user. The wheels track 120 can contain television cable 122 and a plurality of electrical power wires 124 that can be utilized by the flat screen television 105. The wheels track 120 is made of metal or any other suitable material. The pair of roller wheels 130 is received by the wheels track 120 and rolls on the wheels track 120. The pair of roller wheels 130 conducts electricity and is made of copper or any other suitable conductive material. The attachment stem 140 has a first end 142 and a second end 144. The first end 142 of the attachment stem 140 is attached to the pair of roller wheels 130 and extends from the pair of roller wheels 130. The attachment stem 140 is made of metal or any other suitable material. The attachment stem 140 can also contain television cable 122 and a plurality of electrical power wires 124 from the wheels track 120 to be utilized by the flat screen television 105. The television attachment bracket 150 is attached to a back portion 104 of the flat screen television 105. The television attachment bracket 150 secures the back portion 104 of the flat screen television 105 to the second end 144 of the attachment stem 140. The television attachment bracket 150 is secured to the back portion 104 of the flat screen television 105 with a plurality of bolts 152, a plurality of screws 154 or other suitable fasteners.

The slidable television track is a multi-connected railing accessory that introduces a relatively effective medium for suspending and moving a flat screen television with relative ease. Made from relatively sturdy materials, the slidable television track includes a wall or a ceiling pair of rails capable of extending to a desired length. Once positioned, an attachment stem permits attachment of a flat screen television to the pair of rails, a wheels track and a pair of roller wheels made of conductive electricity and cables, that allows a user to slide a flat screen television to a preferred location along a pair of rails without having to independently move a cable unit, sound system or media playing device possibly connected to a cable box. The slidable television track may be readily available at home supply and electronic retailers.

The slidable television track alleviates a necessity of having to move a plurality of wires or other electronics when attempting to place a television in various locations. The slidable television track includes a railing suspension apparatus, that allows a flat screen television to easily glide from one specific point of a room to another desired specific point and provides a user with flexibility when defining their entertainment area.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A slidable television track, comprising:
a pair of rails attached to a ceiling with a plurality of fasteners;
a wheels track disposed between said pair of rails, said wheels track contain television cable and a plurality of electrical power wires that are utilized by a flat screen television;
a pair of roller wheels received by said wheels track, said pair of roller wheels roll on said wheels track, said pair of roller wheels conduct electricity;
an attachment stem with a first end and a second end, said attachment stem contains said television cable and said electrical power wires that are utilized by said flat screen television, said first end of said attachment stem is attached to and extends from said pair of roller wheels; and
a television attachment bracket attached to a back portion of said flat screen television, said television attachment bracket secures said back portion of said flat screen television to said second end of said attachment stem.

2. The slidable television track according to claim 1, wherein said pair of rails are attached to a wall.

3. The slidable television track according to claim 1, wherein said fasteners are a selected one of a plurality of bolts and a plurality of screws.

4. The slidable television track according to claim 1, wherein said pair of rails is made of metal.

5. The slidable television track according to claim 1, wherein said wheels track is approximately 2 inches in width.

6. The slidable television track according to claim 1, wherein said pair of rails and said wheels track have an equal length.

7. The slidable television track according to claim 1, wherein said wheels track is made of metal.

8. The slidable television track according to claim 1, wherein said pair of roller wheels is made of copper.

9. The slidable television track according to claim 1, wherein said attachment stem is made of metal.

10. The slidable television track according to claim 1, wherein said television attachment bracket is secured to said back portion of said flat screen television with a selected one of a plurality of bolts and a plurality of screws.

11. The slidable television track according to claim 1, wherein said flat screen television is moved on said slidable television track by hand.

12. The slidable television track according to claim 1, wherein said flat screen television is moved on said slidable television track with a remote control in communication with said flat screen television.

13. A slidable television track, comprising:
a pair of rails attached to a selected one of a ceiling and a wall with a plurality of fasteners, said fasteners are a selected one of a plurality of bolts and a plurality of screws;
a wheels track disposed between said pair of rails, said wheels track contain television cable and a plurality of electrical power wires that are utilized by a flat screen television, said pair of rails and said wheels track have an equal length;
a pair of roller wheels received by said wheels track, said pair of roller wheels roll on said wheels track, said pair of roller wheels conduct electricity;
an attachment stem with a first end and a second end, said attachment stem contains said television cable and said electrical power wires that are utilized by said flat screen television, said first end of said attachment stem is attached to and extends from said pair of roller wheels; and
a television attachment bracket attached to a back portion of said flat screen television, said television attachment bracket secures said back portion of said flat screen television to said second end of said attachment stem, said television attachment bracket is secured to said back portion of said flat screen television with a selected one of a plurality of bolts and a plurality of screws.

14. The slidable television track according to claim 13, wherein said pair of rails is made of metal.

15. The slidable television track according to claim 13, wherein said wheels track is approximately 2 inches in width.

16. The slidable television track according to claim 13, wherein said wheels track is made of metal.

17. The slidable television track according to claim 13, wherein said pair of roller wheels is made of copper.

18. The slidable television track according to claim 13, wherein said attachment stem is made of metal.

19. The slidable television track according to claim 13, wherein said flat screen television is moved on said slidable television track by hand.

20. The slidable television track according to claim 13, wherein said flat screen television is moved on said slidable television track with a remote control in communication with said flat screen television.
